(19) United States
(12) Patent Application Publication
(10) Pub. No.: US 2026/0256545 A1
(43) Pub. Date: Sep. 3, 2026

(54) METHOD OF GENERATING ORTHODONTIC TREATMENT PLAN BASED ON SEQUENTIAL STAGING TECHNOLOGY, COMPUTING DEVICE FOR PERFORMING THE SAME, AND RECORDING MEDIUM

(71) Applicant: 3D ONS, INC., Seoul (KR)

(72) Inventors: Heonjae CHO, Seoul (KR); Seungyoung OH, Seoul (KR)

(73) Assignee: 3D ONS, INC., Seoul (KR)

(21) Appl. No.: 19/459,696

(22) Filed: Jan. 26, 2026

(30) Foreign Application Priority Data
Feb. 28, 2025 (KR) 10-2025-0026348

(51) Int. Cl. A61C 7/00; A61C 9/00; G06T 7/11

(52) U.S. Cl. CPC A61C 7/002; A61C 9/0046; G06T 7/11; G06T 2207/10076; G06T 2207/30036

(57) ABSTRACT

Provided are a method of generating an orthodontic treatment plan based on a sequential staging technology, a computing device for performing the same, and a recording medium. A method of generating an orthodontic treatment plan based on the sequential staging technology according to various embodiments of the present disclosure, which is a method performed by a computing device, includes generating a three-dimensional (3D) teeth model including a plurality of individual tooth models generated by individually modeling each of a plurality of teeth of a subject and generating an orthodontic treatment plan for performing stepwise orthodontic treatment on teeth requiring orthodontic treatment among the plurality of teeth using the generated 3D teeth model.

### CROSS-REFERENCE TO RELATED APPLICATION

This application claims priority to and the benefit of Korean Patent Application No. 2025-0026348, filed on Feb. 28, 2025, the disclosure of which is incorporated herein by reference in its entirety.

### BACKGROUND

### 1. Field of the Invention

Various embodiments of the present disclosure relate to a method of generating an orthodontic treatment plan based on a sequential staging technology, a computing device for performing the same, and a recording medium, and more particularly to, a method of generating an orthodontic treatment plan based on a sequential staging technology that, in generating an orthodontic treatment plan consisting of a plurality of stages for teeth requiring orthodontic treatment, can generate a realistic orthodontic treatment plan so that each of the teeth can be corrected in stages and sequentially within a correctable range in consideration of a positional relationship between the teeth, a computing device for performing the same, and a recording medium.

### 2. Discussion of Related Art

Generally, uneven dental alignment or malocclusion can cause abnormalities in the development of the teeth themselves, the jawbone, or the like. People with uneven or misaligned teeth may cover their mouths when talking or smiling to others due to their teeth condition, and may also become passive in interpersonal relationships, and thus may have difficulty leading a fulfilling social life.

In addition, when eating food, the food cannot be ground evenly, and the food can remain between teeth, which can lead to various dental diseases or digestive system diseases.

Accordingly, in order to address these issues, orthodontic techniques for continuously applying force to teeth to cause the teeth to move along with the remodeling of the alveolar bone surrounding the teeth are being applied.

Meanwhile, orthodontic treatment requires systematic knowledge of teeth movement and should be based on accurate dental procedures, and systematic monitoring is essential in the actual clinical process.

Conventionally, various programs for orthodontic treatment were developed, and three-dimensional (3D) teeth models were generated and analyzed through these programs to establish more accurate orthodontic treatment plans.

However, teeth movement involves linear movement and rotational movement, and in order to more accurately plan the linear and rotational movements, it is important to accurately set axes and centers of rotation of teeth, and thus information on a root is very important to establish a more accurate orthodontic treatment plan. However, there is a problem that conventional orthodontic programs are difficult to establish an accurate plan because they establish orthodontic treatment plans considering only crown regions of the teeth.

Further, conventional orthodontic treatment plan techniques have a limitation in that they only consider a total amount of orthodontic movement for teeth but do not consider a positional relationship between the teeth at all.

More specifically, a transparent orthodontic (clear alignment) process, which is one representative orthodontic treatment method, is a method of dividing a process of moving teeth from current positions to target positions into stages and moving the teeth by gradually replacing a customized orthodontic device made of transparent plastic.

In the case of the conventional transparent orthodontic process, in generating an orthodontic treatment plan for each stage, there is a problem that since a plan is established so that the process is simply divided into a plurality of stages according to a total amount of orthodontic movement for teeth, without considering a positional relationship between the teeth at all, and consistent orthodontic treatments are performed at each stage, an orthodontic treatment plan that is realistically impossible may be established, such as a plan being designed to move the teeth to places where the teeth cannot move due to the resistance of other teeth, or the like.

Accordingly, there is a need for the development of technology for establishing a realistic orthodontic treatment plan in consideration of not only an amount of orthodontic movement simply required for teeth, but also a positional relationship between the teeth.

The background technology described above is something that the inventor possessed or acquired in the process of deriving the content of the present disclosure and cannot necessarily be said to be a publicly known technology disclosed to the general public prior to the present application.

### SUMMARY OF THE INVENTION

The present disclosure is directed to providing a method of generating an orthodontic treatment plan based on a sequential staging technology, which is capable of performing accurately modeling not only on crown regions but also on root regions to generate a three-dimensional (3D) teeth model, using the generated 3D teeth model to generate an orthodontic treatment plan, and thus generating a more accurate orthodontic treatment plan in consideration of both crowns and roots, a computing device for performing the same, and a recording medium.

The present disclosure is also directed to providing a method of generating an orthodontic treatment plan based on a sequential staging technology, which is capable of, in generating an orthodontic treatment plan including a plurality of orthodontic stages for the purpose of utilizing transparent orthodontic devices, determining an amount of orthodontic movement for teeth in consideration of a positional relationship between the teeth, that is, separation distances from adjacent teeth, so that each tooth can be corrected in stages within an orthodontically correctable range, a computing device for performing the same, and a recording medium.

That is, the present disclosure is also directed to providing a method of generating an orthodontic treatment plan based on a sequential staging technology, which is capable of, in establishing an orthodontic treatment plan for teeth requiring orthodontic treatment, allowing only teeth that do not have resistance from other teeth to be selectively corrected within an orthodontically correctable range, and allowing some teeth that have resistance from other teeth to be corrected sequentially and in stages after waiting and the resistance has disappeared so that a realistic orthodontic treatment plan can be established, a computing device for performing the same, and a recording medium.

Objects of the present disclosure are not limited to the above-described objects and other objects which have not been described may be clearly understood by those skilled in the art from the above descriptions.

According to an aspect of the present disclosure, there is provided a method of generating an orthodontic treatment plan based on a sequential staging technology, which is a method performed by a computing device and includes generating a 3D teeth model including a plurality of individual tooth models generated by individually modeling each of a plurality of teeth of a subject, and generating an orthodontic treatment plan for performing stepwise orthodontic treatment on teeth requiring orthodontic treatment among the plurality of teeth using the generated 3D teeth model.

The generating of the orthodontic treatment plan may include setting a plurality of orthodontic stages on the basis of an initial position and a target position of at least one individual tooth model, which corresponds to at least one tooth requiring orthodontic treatment, among the plurality of individual tooth models, generating a plurality of unit orthodontic treatment plans corresponding to each of the plurality of set orthodontic stages on the basis of a positional relationship between the plurality of individual tooth models in each of the plurality of set orthodontic stages, and generating an orthodontic treatment plan for sequentially performing each of the plurality of generated unit orthodontic treatment plans.

The generating of the plurality of unit orthodontic treatment plans may include in any one of the plurality of set orthodontic stages, calculating a separation distance between the at least one individual tooth model and an adjacent individual tooth model corresponding to an adjacent tooth positioned in an orthodontic treatment direction of the at least one tooth, determining a target orthodontic movement amount of the at least one tooth on the basis of the calculated separation distance, and generating a unit orthodontic treatment plan corresponding to an orthodontic stage subsequent to the any one orthodontic stage according to the determined target orthodontic movement amount.

The determining of the target orthodontic movement amount may include, when the calculated separation distance is greater than or equal to a preset reference orthodontic movement amount, determining the reference orthodontic movement amount to be the target orthodontic movement amount of the at least one tooth.

The determining of the target orthodontic movement amount may include, when the calculated separation distance is less than a preset reference orthodontic movement amount, determining the calculated separation distance to be the target orthodontic movement amount of the at least one tooth.

The determining of the target orthodontic movement amount may include, when the calculated separation distance is less than a preset threshold value, determining the target orthodontic movement amount of the at least one tooth to be 0.

In the determining of the target orthodontic movement amount, the target orthodontic movement amount of the at least one tooth may be determined based on the calculated separation distance, and the determining of the target orthodontic movement amount may include, when the number of the set orthodontic stages exceeds a reference number, correcting the determined target orthodontic movement amount of the at least one tooth according to a predetermined target orthodontic movement amount of the adjacent tooth.

The calculated separation distance may be a crown separation distance calculated based on crown regions of the at least one individual tooth model and the adjacent individual tooth model, and the determining of the target orthodontic movement amount may include, when orthodontic treatment is performed on the crown region of the at least one individual tooth model according to the generated unit orthodontic treatment plan, calculating an expected orthodontic movement amount of a root region of the at least one individual tooth model, calculating a root separation distance on the basis of the root region of the at least one individual tooth model and a root region of the adjacent individual tooth model, on the basis of the calculated expected orthodontic movement amount, and correcting the target orthodontic movement amount of the at least one tooth included in the generated unit orthodontic treatment plan on the basis of the calculated root separation distance.

The calculating of the root separation distance may include setting an axis in a longitudinal direction of the at least one individual tooth model on the basis of a feature point extracted from the crown region of the at least one individual tooth model and a feature point extracted from the root region of the at least one individual tooth model, and calculating an expected orthodontic movement amount of the root region of the at least one individual tooth model when the crown region of the at least one individual tooth model is corrected by a predetermined orthodontic movement amount, on the basis of the set axis.

The generating of the 3D teeth model may include segmenting teeth scan data into a plurality of first regions corresponding to each of the plurality of teeth, segmenting teeth computed tomography (CT) data a plurality of second regions corresponding to each of the plurality of teeth, and generating a plurality of individual tooth models by registering the plurality of segmented first regions and the plurality of segmented second regions and generating a 3D teeth model by placing each of the plurality of generated individual tooth models at a position of a tooth corresponding to each of the plurality of generated individual tooth models.

According to another aspect of the present disclosure, there is provided a computing device that performs a method of generating an orthodontic treatment plan based on a sequential staging technology and includes a processor, a network interface, a memory, and a computer program that is loaded into the memory and executed by the processor, wherein the computer program used in a method performed by the computing device includes an instruction for generating a 3D teeth model including a plurality of individual tooth models generated by individually modeling each of a plurality of teeth of a subject, and an instruction for generating an orthodontic treatment plan for performing stepwise orthodontic treatment on teeth requiring orthodontic treatment among the plurality of teeth using the generated 3D teeth model.

According to still another aspect of the present disclosure, there is provided a non-transitory recording medium which is readable by a computing device, on which a computer program is stored to perform a method of generating an orthodontic treatment plan based on a sequential staging technology, and which is coupled to the computing device, wherein the method includes generating a 3D teeth model including a plurality of individual tooth models generated by individually modeling each of a plurality of teeth of a subject, and generating an orthodontic treatment plan for performing stepwise orthodontic treatment on teeth requiring orthodontic treatment among the plurality of teeth using the generated 3D teeth model.

Other specific details of the present disclosure are included in detailed descriptions and drawings.

### BRIEF DESCRIPTION OF THE DRAWINGS

The following drawings attached to this specification illustrate exemplary embodiments of the present disclosure and, together with the detailed description of the present disclosure, serve to further understand the technical idea of the present disclosure, and therefore, the present disclosure should not be interpreted as being limited to matters described in such drawings.

The above and other objects, features and advantages of the present disclosure will become more apparent to those of ordinary skill in the art by describing exemplary embodiments thereof in detail with reference to the accompanying drawings, in which:

FIG. 1 is a diagram illustrating a system for generating an orthodontic treatment plan based on a sequential staging technology according to an embodiment of the present disclosure;

FIG. 2 is a diagram illustrating a hardware configuration of a computing device according to another embodiment of the present disclosure;

FIG. 3 is a flowchart of a method of generating an orthodontic treatment plan based on a sequential staging technology according to still another embodiment of the present disclosure;

FIG. 4 is a flowchart for describing a method of generating a three-dimensional (3D) teeth model in various embodiments;

FIGS. 5A-5B are a set of diagrams illustrating exemplary teeth scan data and teeth computed tomography (CT) data used for generating the 3D teeth model in various embodiments;

FIGS. 6A-6B are a set of diagrams illustrating exemplary forms in which tooth scan data and tooth CT data are registered in various embodiments;

FIG. 7 is a flowchart for describing a method of generating an orthodontic treatment plan in various embodiments;

FIG. 8 is a diagram illustrating a feature point on a crown region, a feature point on a root region, and an axis in a longitudinal direction that is set based on the feature points in various embodiments;

FIG. 9 is a diagram illustrating an example of changes in positions of a crown and a root due to a tooth movement correction in various embodiments;

FIG. 10 is a diagram illustrating an example of changes in angles of a crown and a root due to a tooth rotation correction in various embodiments; and

FIGS. 11 to 14 are diagrams illustrating an example of a process of performing orthodontic treatment in stages through an orthodontic treatment plan generated according to various embodiments of the present disclosure.

### DETAILED DESCRIPTION OF EXEMPLARY EMBODIMENTS

Advantages and features of the present disclosure and methods of achieving the same will be clearly understood with reference to the accompanying drawings and embodiments described in detail below. However, the present disclosure is not limited to the embodiments to be disclosed below but may be implemented in various different forms. The embodiments are provided in order to fully explain the present embodiments and fully explain the scope of the present disclosure for those skilled in the art. The scope of the present disclosure is only defined by the appended claims.

Terms used in this specification are considered in a descriptive sense only and not for purposes of limitation. In this specification, the singular forms include the plural forms unless the context clearly indicates otherwise. It will be understood that the terms “comprise” and/or “comprising” when used herein, specify some stated components, steps, operations and/or elements, but do not preclude the presence or addition of one or more other components, steps, operations and/or elements.

Like reference numerals refer to like elements throughout the specification, and the term “and/or” includes each and every combination of one or more of stated elements. It should be understood that, although the terms “first,” “second,” etc., may be used herein to describe various components, these components are not limited by these terms. The terms are only used to distinguish one component from another component. Therefore, it should be understood that a first component to be described below may be a second component within the technical scope of the present disclosure.

Terms described in the specification such as “unit” and “module” refer to software or a hardware component such as a field-programmable gate array (FPGA) or an Application-Specific Integrated Circuit (ASIC), and the unit performs certain functions. However, the “unit” or “module” is not limited to software or hardware. The “unit” or “module” may be configured in a storage medium that may be addressed or may be configured to be executed by at least one processor. Therefore, examples of the “unit” or “module” include components such as software components, object-oriented software components, class components and task components, and processes, functions, attributes, procedures, subroutines, segments of program codes, drivers, firmware, micro codes, circuits, data, database, data structures, tables, arrays, and variables. Components and functions provided from “units” or “modules” may be combined into a smaller number of components and “units” or “modules” or may be further separated into additional components and “units.”

Spatially relative terms such as “below,” “beneath,” “lower,” “above,” “upper,” and the like may be used to easily describe a relationship between one component and other components as illustrated in the drawings. Spatially relative terms should be understood to include different directions of the element during use or operation in addition to the direction illustrated in the drawing. For example, when one component illustrated in a drawing is flipped, one component described as being “below” or “beneath” the other component may be placed “above” the other component. Therefore, the exemplary term “below” may encompass both downward and upward directions. Components may be arranged in different directions so that spatially relative terms may be interpreted according to the arrangement.

As used herein, the expressions “first,” “second,” etc., unless the context indicates otherwise, are used to refer to a plurality of similar objects and to distinguish one object from another, and do not limit the order or importance among the objects.

As used herein, the expressions “A, B, and C,” “A, B, or C,” “A, B, and/or C,” or “at least one of A, B, and C,” “at least one of A, B, or C,” “at least one of A, B, and/or C,” “at least one selected from A, B, and C,” “at least one selected from A, B, or C,” “at least one selected from A, B, and/or C,” and the like may mean each of listed items or any possible combination of the listed items. For example, the expression “at least one selected from A and B” may refer to all cases of (1) including A, (2) including at least one of A, (3) including B, (4) including at least one of B, (5) including at least one of A and at least one of B, (6) including at least one of A and B, (7) including at least one of B and A, and (8) including both A and B.

The expression “based on” or “on the basis of” as used herein is used to describe one or more factors that influence a decision, act of determination, or action described in a phrase or sentence containing the expression, and this expression does not exclude additional factors that influence the decision, act of determination, or action.

As used herein, the expression that one component (e.g., a first component) is “connected” or “coupled” to the other component (e.g., a second component) may mean that the one component is directly connected or coupled to the other component, as well as connected or coupled through a new component (e.g., a third component).

The expression “configured to” as used herein may have the meanings “set to,” “having the capacity to,” “modified to do,” “made to,” “capable of,” etc., according to the context. The corresponding expression is not limited to the meaning of “specifically designed to in hardware,” for example, a processor configured to perform a particular operation may mean a generic-purpose processor for performing a specific operation thereof by executing software.

Unless otherwise defined, all terms (including technical and scientific terms) used herein can be used as is customary in the art to which this disclosure belongs. Further, it will be further understood that terms, such as those defined in commonly used dictionaries, will not be interpreted in an idealized or overly formal sense unless expressly so defined herein.

In this specification, a computer means any type of hardware device including at least one processor and may be understood to encompass software configurations operating on the corresponding hardware device according to an embodiment. For example, the computer may be understood to include a smartphone, a tablet personal computer (PC), a desktop, a notebook, and all user clients and applications running on each device, but the present disclosure is not limited thereto.

Hereinafter, embodiments of the present disclosure will be described in detail with reference to the accompanying drawings.

Although each operation described in this specification is described as being performed by a computer, a subject of each operation is not limited thereto, and at least a portion of each operation may be performed by different devices according to some embodiments.

Orthodontic treatment refers to the movement of a tooth, more specifically, a root of the tooth, between bones (e.g., jawbone or skull).

A periodontal ligament (e.g., including cells, collagen fibers, blood vessels, and tissue fluid) that has a thickness of about 0.5 mm is present between the root (hard tissue) and the bone (hard tissue), and the surrounding periodontal ligaments are alive as blood flows through blood vessels included in the periodontal ligament.

In this case, when force is applied to the tooth for orthodontic treatment purposes, such as when orthodontic braces and the like are used, as the tooth is pushed out, the force is transmitted to the root of the tooth and the root moves due to this force. During this process, the periodontal ligament between the root and the bone in a movement direction of the root is reduced from 0.5 mm to about 0.2 mm, and a portion opposite to the movement direction of the root is increased by the reduced size.

In this way, when the thickness of the periodontal ligament is reduced, the blood vessels narrow, a blood flow rate is reduced, an amount of oxygen supplied to the periodontal ligament is reduced, and accordingly, cells (osteoclasts) that absorb the surrounding roots and bone in an attempt to restore the periodontal ligament to an original thickness thereof are made.

During this process, the bone is absorbed faster than the root, and thus the bone is reduced and space is generated to allow flesh to grow back in, and as this process is repeated, the tooth moves to a target position thereof.

Meanwhile, the blood vessels in the periodontal ligament region where the thickness has decreased are compressed accordingly, and when the thickness becomes 0.2 mm or less, the blood vessels are completely compressed and blood stops flowing. There is a problem that when the thickness becomes 0.2 mm or less, the blood flowing through the blood vessels stops flowing, and thus the above processes cannot be repeated and the surrounding cells die, which causes the teeth to not move.

Therefore, in correcting a tooth, it is very important to precisely control the movement amount of root so that the periodontal ligament is pressed to reduce a thickness thereof by at least 0.2 mm to 0.25 mm.

Accordingly, a method of generating an orthodontic treatment plan based on a sequential staging technology, a computing device for performing the same, and a recording medium according to various embodiments of the present disclosure may more accurately implement a three-dimensional (3D) teeth model on the basis of anatomical information on not only a crown of a tooth but also a root and generate an orthodontic treatment plan on the basis of the 3D teeth model to generate an orthodontic treatment plan capable of precisely controlling an amount of movement of the root.

Further, a transparent orthodontic (clear alignment) process is one orthodontic process, and more specifically, the transparent orthodontic process is a method of dividing a process of moving a tooth from a current position of the tooth to a target position into stages and moving the tooth by gradually replacing a customized orthodontic device made of transparent plastic.

In the case of the conventional transparent orthodontic process, in generating an orthodontic treatment plan for each stage, there is a problem that, since a positional relationship between teeth is not considered at all, an orthodontic treatment plan that is realistically impossible may be established, such as a plan being designed to move the teeth to places where the teeth cannot move.

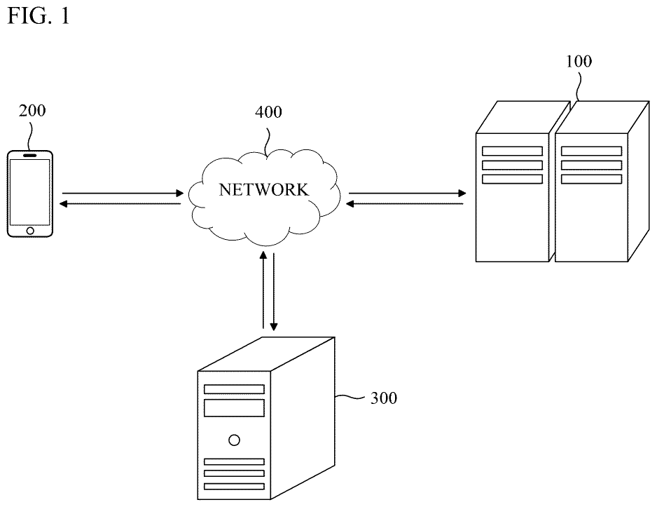

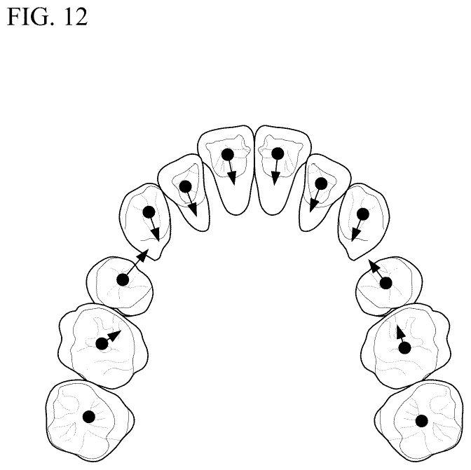

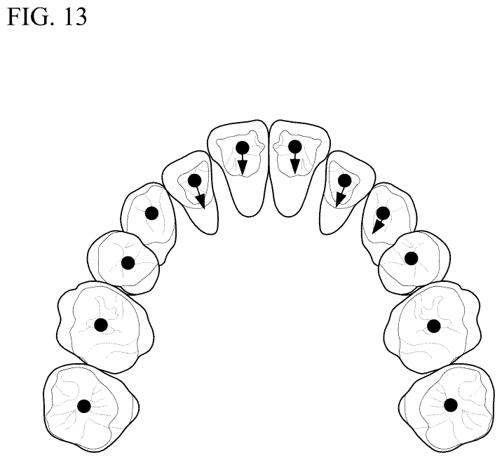

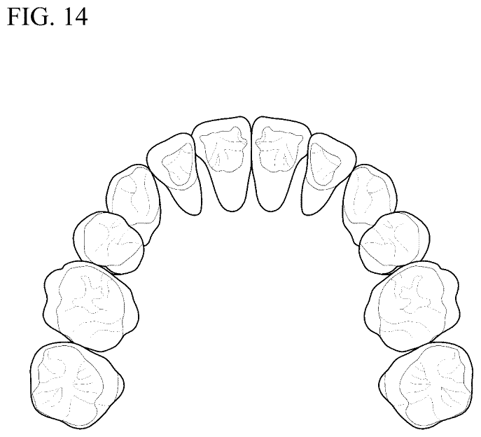

Accordingly, a method of generating an orthodontic treatment plan based on a sequential staging technology, a computing device for performing the same, and a recording medium according to various embodiments of the present disclosure may generate a realistic orthodontic treatment plan in which, in generating an orthodontic treatment plan including a plurality of orthodontic stages, an amount of orthodontic movement of each tooth is determined in consideration of a positional relationship between the teeth, that is, separation distances from adjacent teeth, so that each tooth can be corrected in stages within an orthodontically correctable range. Hereinafter, this will be described in more detail with reference to FIGS. 1 to 14.

FIG. 1 is a diagram illustrating a system for generating an orthodontic treatment plan based on a sequential staging technology according to an embodiment of the present disclosure.

Referring to FIG. 1, the system for generating the orthodontic treatment plan based on the sequential staging technology according to the embodiment of the present disclosure may include a computing device 100, a user terminal 200, an external server 300, and a network 400.

Here, the system for generating the orthodontic treatment plan based on the sequential staging technology illustrated in FIG. 1 is provided according to one embodiment, and components of the system are not limited to those of the embodiment illustrated in FIG. 1, and some components may be added, changed, or deleted omitted as necessary.

In an embodiment, the computing device 100 may provide a service for generating an orthodontic treatment plan based on a sequential staging technology.

Here, the service for generating the orthodontic treatment plan based on the sequential staging technology that is provided by the computing device 100 may relate to an orthodontic treatment plan required for performing a transparent orthodontic process, that is, an orthodontic strategy for performing a plurality of orthodontic stages sequentially and in stages.

As described above, the transparent orthodontic process is divided into a plurality of orthodontic stages, and for each orthodontic stage, a transparent orthodontic device (e.g., an aligner) is manufactured for orthodontic treatment.

The transparent orthodontic devices used in each orthodontic stage are generally made of thermoplastic plastic materials such as thermoplastic polyurethane (TPU), polyethylene terephthalate glycol (PETG), etc., which have elastic properties.

That is, when the transparent orthodontic device is first worn, the shape of the transparent orthodontic device may be slightly changed according to the current arrangement of the teeth, but due to the nature of the material, the transparent orthodontic device has the property of trying to return to its original shape, and thus force is continuously applied to the teeth, and this force gradually moves the teeth, resulting in orthodontic treatment.

Considering these points, an orthodontic strategy for performing a plurality of orthodontic stages sequentially and in stages may include not only information on how and in which direction each tooth will be corrected at each stage, but also, in some cases, information for modeling the transparent orthodontic device to be used at each orthodontic stage on the basis of this information or results of the modeling.

In various embodiments, the computing device 100 may generate a 3D teeth model for teeth of a subject requiring orthodontic treatment and generate an orthodontic treatment plan for correcting the teeth of the subject in stages based on the 3D teeth model.

In various embodiments, the computing device 100 may be connected to the user terminal 200 through the network 400 and provide the service for generating the orthodontic treatment plan based on the sequential staging technology to the user terminal 200. For example, the computing device 100 may generate and provide an orthodontic treatment plan to the user terminal 200 in response to a request for generating an orthodontic treatment plan that is obtained from the user terminal 200.

Here, the user terminal 200 may be any form of entity(entities) in a system having a mechanism for communication with the computing device 100. For example, the user terminal 200 may include a PC, a notebook, a mobile terminal, a smartphone, a tablet PC, a wearable device, etc., and include any type of terminal capable of being connected to wired/wireless networks. Further, the user terminal 200 may include any computing device implemented by at least one of an agent, an application programming interface (API), and a plug-in. Further, the user terminal 200 may include an application source and/or a client application.

Further, here, the network 400 may be a connection structure that allows information exchange between individual nodes, such as a plurality of terminals, and servers. For example, the network 400 may include a local region network (LAN), a wide region network (WAN), the Internet (World Wide Web (WWW)), wired and wireless data communication networks, a telephone network, wired and wireless television communication networks, a controller region network (CAN), Ethernet, etc.

The wireless data communication network includes 3G, 4G, 5G, 3rd Generation Partnership Project (3GPP), 5th Generation Partnership Project (5GPP), Long-Term Evolution (LTE), World Interoperability for Microwave Access (WiMAX), Wi-Fi, the Internet, a LAN, a wireless LAN, a WAN, a personal region network (PAN), Radio Frequency (RF), a Bluetooth network, a near-field communication (NFC) network, a satellite broadcasting network, an analog broadcasting network, a digital multimedia broadcasting (DMB) network, etc., but the present disclosure is not limited thereto.

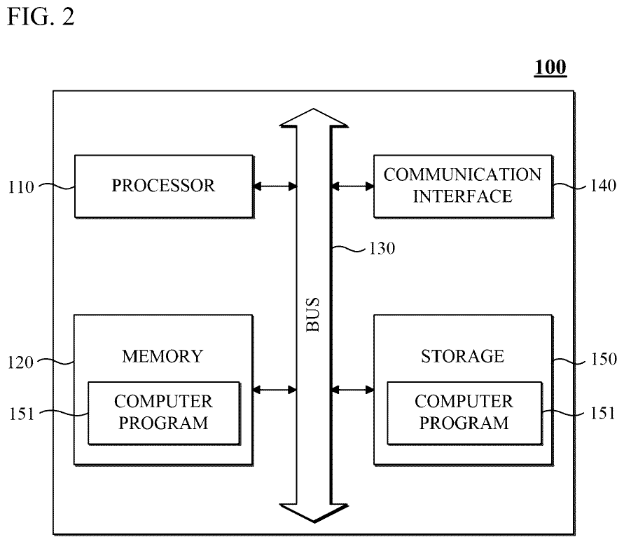

In an embodiment, the external server 300 may be connected to the computing device 100 through the network 400, and may store and manage information and data necessary for the computing device 100 to provide a method of generating an orthodontic treatment plan based on a sequential staging technology, or may collet, store, and manage information and data generated as the computing device 100 provides the method of generating an orthodontic treatment plan based on the sequential staging technology. For example, the external server 300 may be a storage server separately installed outside the computing device 100, but the present disclosure is not limited thereto. Hereinafter, a hardware configuration of the computing device 100 will be described with reference to FIG. 2.

FIG. 2 is a diagram illustrating a hardware configuration of a computing device according to another embodiment of the present disclosure.

Referring to FIG. 2, a computing device 100 according to another embodiment of the present disclosure may include one or more processors 110, a memory 120 for loading a computer program 151 executed by the processor 110, a bus 130, a communication interface 140, and a storage 150 for storing the computer program 151. Here, only components relevant to the embodiment of the present disclosure are illustrated in FIG. 2. Therefore, it can be seen by those skilled in the art that the present disclosure may include general-purpose components other than the components illustrated in FIG. 2.

The processor 110 controls the overall operation of each component of the computing device 100. The processor 110 may include a central processing unit (CPU), a micro-processor unit (MPU), a micro controller unit (MCU), or any type of processor well known in the art of the present disclosure.

Further, the processor 110 may perform operations of at least one application or program for executing methods according to embodiments of the present disclosure, and the computing device 100 may include one or more processors.

In various embodiments, the processor 110 may further include a random access memory (RAM, not illustrated) and a read-only memory (ROM, not illustrated) that are for temporarily and/or permanently storing signals (or data) processed within the processor 110. Further, the processor 110 may be implemented in the form of a system-on-chip (SoC) including at least one of a GPU, a RAM, and a ROM.

The memory 120 stores various types of data, commands, and/or information. The memory 120 may load the computer program 151 from the storage 150 to perform methods/operations according to various embodiments of the present disclosure. When the computer program 151 is loaded into the memory 120, the processor 110 may perform the methods/operations by executing one or more instructions constituting the computer program 151. The memory 120 may be implemented as a volatile memory, such as a RAM, but the technical scope of the present disclosure is not limited thereto.

The bus 130 provides communication between the components of the computing device 100. The bus 130 may be implemented as one of various types of buses, such as an address bus, a data bus, a control bus, etc.

The communication interface 140 supports wired and wireless Internet communication of the computing device 100. Further, the communication interface 140 may support various communication methods other than Internet communication. To this end, the communication interface 140 may include a communication module well known in the art of the present disclosure. In some embodiments, the communication interface 140 may be omitted.

The storage 150 may non-temporarily store the computer program 151. When a process of generating an orthodontic treatment plan based on a sequential staging technology is performed through the computing device 100, the storage 150 may store various types of information necessary to provide the process of generating an orthodontic treatment plan based on the sequential staging technology.

The storage 150 may include a non-volatile memory, such as a ROM, an erasable programmable ROM (EPROM), an electrically erasable programmable ROM (EEPROM), a flash memory, etc., a hard disk, a removable disk, or any type of computer-readable recording medium well known in the art to which the present disclosure pertains.

The computer program 151 may include one or more instructions that, when loaded into the memory 120, cause the processor 110 to perform the methods/operations according to various embodiments of the present disclosure. That is, the processor 110 may perform the methods/operations according to various embodiments of the present disclosure by executing the one or more instructions.

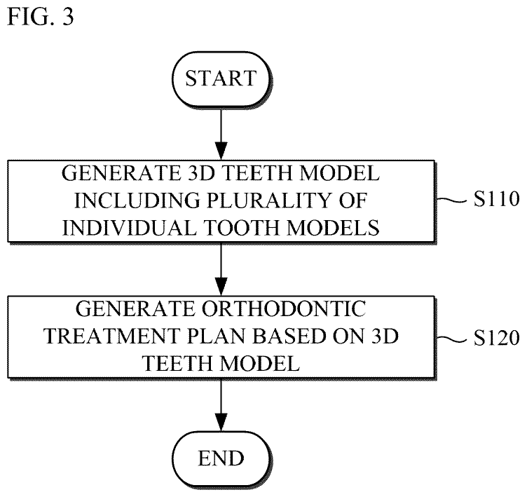

In an embodiment, the computer program 151 may include one or more instructions for performing the method of generating an orthodontic treatment plan based on the sequential staging technology which includes generating a 3D teeth model including a plurality of individual tooth models generated by individually modeling each of a plurality of teeth of a subject, and generating an orthodontic treatment plan at performs stepwise orthodontic treatment on the plurality of teeth using the generated 3D teeth models. Hereinafter, a method of generating an orthodontic treatment plan based on a sequential staging technology performed by the computing device 100 will be described with reference to FIGS. 3 to 14.

FIG. 3 is a flowchart of a method of generating an orthodontic treatment plan based on a sequential staging technology according to still another embodiment of the present disclosure.

Referring to FIG. 3, in operation S110, the computing device 100 may generate a 3D teeth model for teeth of a subject on the basis of anatomical information on a crown and root of a tooth.

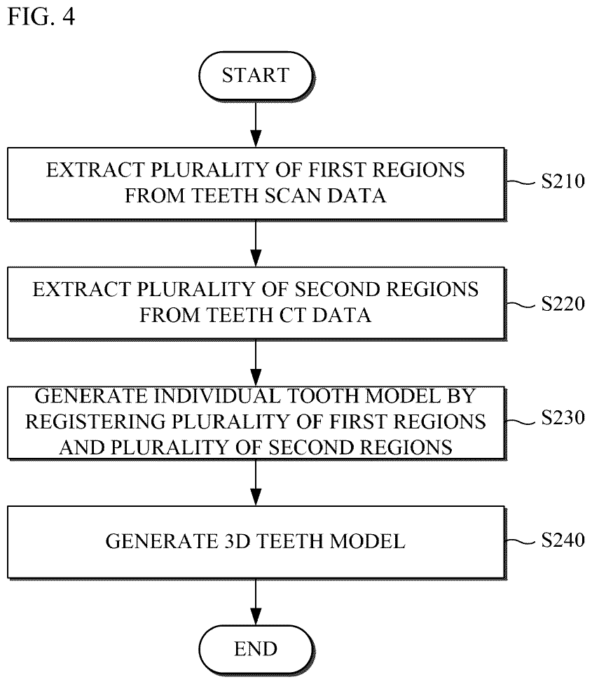

In various embodiments, the computing device 100 may generate a 3D teeth model including a plurality of individual tooth models after individually modeling each of the plurality of teeth on the basis of data corresponding to the plurality of teeth of the subject. Hereinafter, this will be described with reference to FIGS. 4 to 6.

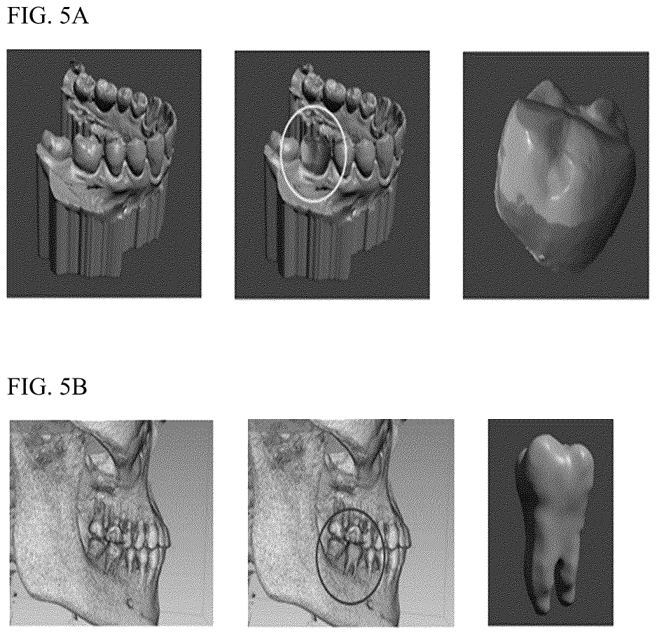

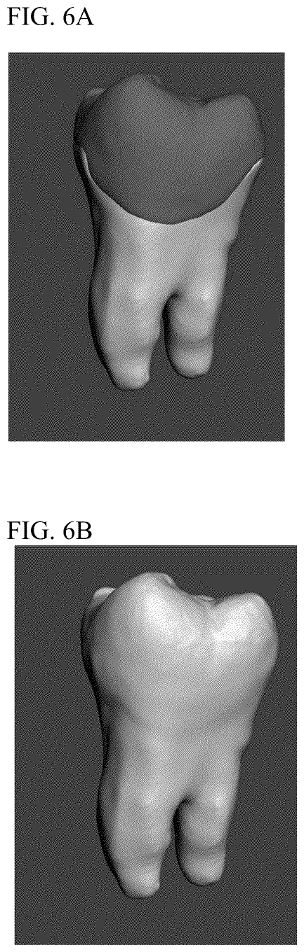

FIG. 4 is a flowchart for describing a method of generating a 3D teeth model in various embodiments, FIG. 5 is a set of diagrams illustrating exemplary teeth scan data and teeth computed tomography (CT) data used for generating the 3D teeth model in various embodiments, and FIG. 6 is a set of diagrams illustrating exemplary forms in which tooth scan data and tooth CT data are registered in various embodiments.

Referring to FIGS. 4 to 6, in operation S210, the computing device 100 may segment the teeth scan data into a plurality of first regions corresponding to each of the plurality of teeth (see FIG. 5A). For example, the computing device 100 may set region of interests (ROIs) corresponding to each of the plurality of teeth on the teeth scan data and perform segmentation to extract the plurality of first regions using the set ROIs.

In this case, the computing device 100 may form polygon data using the teeth scan data and perform polygon data segmentation to extract the plurality of first regions in the form of polygon data.

In operation S220, the computing device 100 may segment the teeth CT data into a plurality of second regions corresponding to each of the plurality of teeth (see FIG. 5B). For example, the computing device 100 may set ROIs corresponding to each of the plurality of teeth on the teeth CT data and perform segmentation to extract the plurality of second regions using the set ROIs.

In this case, the computing device 100 may extract the plurality of second regions in the form of a 3D image by performing 3D image data segmentation in consideration of the fact that the teeth CT data is 3D image data.

In operation S230, the computing device 100 may generate a plurality of individual tooth models by registering the plurality of first regions and the plurality of second regions (see FIG. 6).

In various embodiments, the computing device 100 may perform image-to-image registration on the plurality of first regions and the plurality of second regions. For example, the computing device 100 may convert the plurality of first regions extracted in the form of polygon data into the form of image data and register the plurality of first regions converted into the form of image data and the plurality of second regions extracted in the form of image data (e.g., at least one of landmark-based registration and/or voxel-based registration).

In various embodiments, the computing device 100 may perform polygon-to-polygon registration on the plurality of first regions and the plurality of second regions. For example, the computing device 100 may convert the plurality of second regions extracted in the form of image data into the form of polygon data and register the plurality of second regions converted into the form of polygon data and the plurality of first regions extracted in the form of polygon data (e.g., at least one of landmark-based registration and/or voxel-based registration).

In various embodiments, the computing device 100 may replace the crown region included in the plurality of second regions with the crown region included in the plurality of first regions in consideration of the fact that the teeth scan data has a higher accuracy for a crown region than the teeth CT data. Through this, more accurate modeling may be performed not only on the crown region but also on the root region.

In operation S240, the computing device 100 may generate a 3D teeth model by placing each of the plurality of individual tooth models at a position of a tooth corresponding to each of the plurality of individual tooth models.

Referring to FIG. 3 again, in operation S120, the computing device 100 may generate an orthodontic treatment plan using the 3D teeth model generated in operation S110.

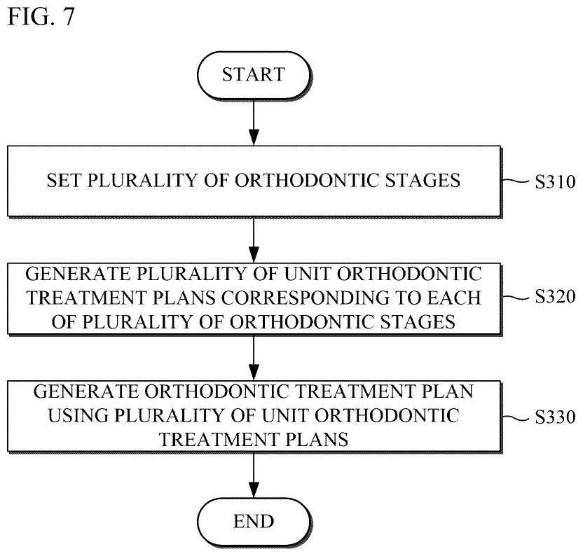

In various embodiments, the computing device 100 may generate an orthodontic treatment plan including a plurality of orthodontic stages for the purpose of correcting a plurality of teeth of a subject in stages on the basis of a transparent orthodontic process. Hereinafter, this will be described below with reference to FIGS. 7 to 14.

FIG. 7 is a flowchart for describing a method of generating an orthodontic treatment plan in various embodiments.

Referring to FIG. 7, in operation S310, the computing device 100 may set a plurality of orthodontic stages.

In various embodiments, the computing device 100 may set the plurality of orthodontic stages on the basis of an initial position and a target position of at least one individual tooth model, which corresponds to at least one tooth requiring orthodontic treatment, among a plurality of individual tooth models.

Here, setting the orthodontic stages may mean determining the number of orthodontic stages to perform orthodontic treatment, but the present disclosure is not limited thereto.

For example, the computing device 100 may calculate a total amount of orthodontic movement on the basis of initial positions and target positions of teeth requiring orthodontic treatment and determine the number of orthodontic stages required for orthodontic treatment by dividing the total amount of orthodontic movement by a preset reference orthodontic movement amount.

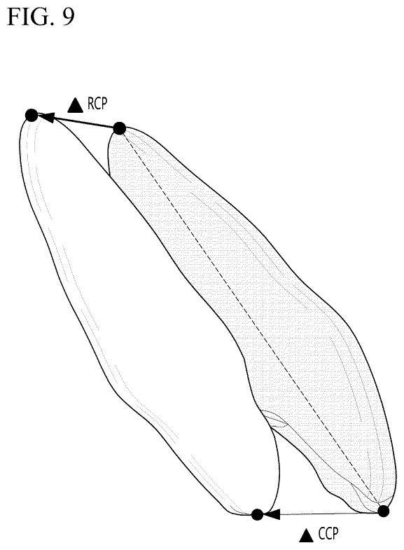

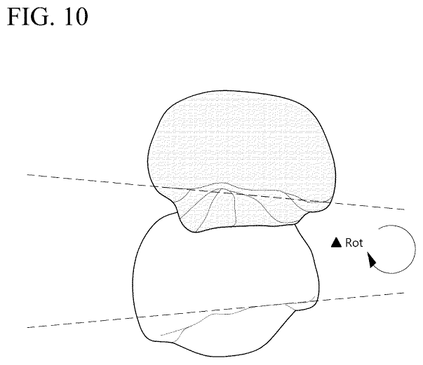

Here, tooth correction includes movement correction for moving a tooth as illustrated in FIG. 9 and rotation correction for rotating a tooth as illustrated in FIG. 10. Accordingly, the reference orthodontic movement amount may include a reference movement amount (e.g., 0.3 mm) and a reference rotation amount (e.g., 3 degrees) in at least one of X-axis, Y-axis, and Z-axis directions, but the present disclosure is not limited thereto.

In various embodiments, when correction is required for two or more teeth, the computing device 100 may set orthodontic stages on the basis of initial positions and target positions of individual tooth models corresponding to each of the two or more teeth, and determine the number of orthodontic stages on the basis of the teeth requiring the largest amount of orthodontic movement, but the present disclosure is not limited thereto.

Here, the number of orthodontic stages determined according to the above method is temporarily determined to establish unit orthodontic treatment plans, and the number of orthodontic stages may be flexibly adjusted according to the unit orthodontic treatment plans for each orthodontic stage established through operations described below. For example, when the computing device 100 sets 10 orthodontic stages according to the total amount of orthodontic movement and the reference orthodontic movement amount and establishes 10 unit orthodontic treatment plans corresponding to the 10 orthodontic stages, but a target orthodontic movement amount is not achieved even when the last 10th unit orthodontic treatment plan is performed, the computing device 100 may additionally set at least one orthodontic stage to achieve the target orthodontic movement amount. Conversely, when the computing device 100 sets 10 orthodontic stages, but a target orthodontic movement amount is achieved with only unit orthodontic treatment plans corresponding to some of the 10 orthodontic stages, the computing device 100 may exclude the remaining orthodontic stages from the orthodontic treatment plan.

Further, according to various embodiments of the present disclosure, the number of orthodontic stages is described as being first determined based on the total amount of orthodontic movement and the preset reference orthodontic movement amount and then the unit orthodontic treatment plans for each orthodontic stage being established, but the present disclosure is not limited thereto, and the orthodontic stages and the unit orthodontic treatment plans for the corresponding orthodontic stages may be set sequentially and in stages, such as generating an initial unit orthodontic treatment plan on the basis of a current tooth condition and generating a next unit orthodontic treatment plan in consideration of a tooth condition when correction is performed according to the initial unit orthodontic treatment plan, and the like.

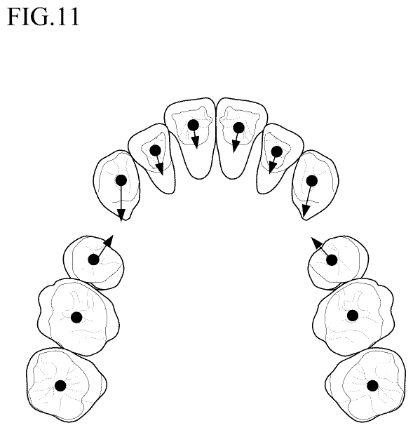

In operation S320, the computing device 100 may generate a plurality of unit orthodontic treatment plans corresponding to each of the plurality of orthodontic stages set in operation S310 (see FIGS. 11 to 14).

In various embodiments, the computing device 100 may generate the plurality of unit orthodontic treatment plans corresponding to each of the plurality of orthodontic stages on the basis of positional relationships between the plurality of individual tooth models.

More specifically, first, the computing device 100 may calculate, in each of the plurality of orthodontic stages, a separation distance between at least one individual tooth model (hereinafter referred to as a “first individual tooth model”) corresponding to at least one tooth requiring orthodontic treatment (hereinafter referred to as a “first tooth”) among the plurality of individual tooth models, and an adjacent individual tooth model (hereinafter referred to as a “second individual tooth model”) corresponding to an adjacent tooth (hereinafter referred to as a “second tooth”) positioned adjacent to the at least one individual tooth model in an orthodontic treatment direction.

For example, the computing device 100 may calculate a crown separation distance on the basis of a feature point present on a crown region for the first individual tooth model and the second individual tooth model. For example, the computing device 100 may extract crown center points (CCPs) as feature points present on the crown regions of the first individual tooth model and the second individual tooth model, and calculate a crown separation distance as a separation distance between the first individual tooth model and the second individual tooth model by calculating a distance between the CCP on the first individual tooth model and the CCP on the second individual tooth model.

Next, the computing device 100 may determine a target orthodontic movement amount of the first tooth on the basis of the separation distance between the first individual tooth model and the second individual tooth model.

For example, when the separation distance between the first individual tooth model and the second individual tooth model is greater than or equal to the preset reference orthodontic movement amount, the computing device 100 may determine the reference orthodontic movement amount to be the target orthodontic movement amount of the first tooth.

As another example, when the separation distance between the first individual tooth model and the second individual tooth model is less than the preset reference orthodontic movement amount, the computing device 100 may determine the separation distance between the first individual tooth model and the second individual tooth model to be the target orthodontic movement amount of the first tooth.

As still another example, when the separation distance between the first individual tooth model and the second individual tooth model is less than a preset threshold value, the computing device 100 may determine the target orthodontic movement amount of the first tooth to be 0.

That is, when determining a target orthodontic movement amount of a tooth to be corrected, the computing device 100 allows the tooth to be corrected by a maximum orthodontic movement amount when a distance from an adjacent tooth is large, allows the tooth to be corrected only as much as possible when the distance from the adjacent tooth is small, or allows the tooth to be maintained in a current position.

In various embodiments, the computing device 100 may determine a target orthodontic movement amount of the first individual tooth model on the basis of the separation distance between the first individual tooth model and the second individual tooth model and correct the target orthodontic movement amount of the first tooth when it is determined that the number of orthodontic stages is unnecessarily too large.

For example, when the separation distance between the first individual tooth model and the second individual tooth model is less than the preset reference orthodontic movement amount, the computing device 100 may determine the separation distance between the first individual tooth model and the second individual tooth model to be the target orthodontic movement amount of the first tooth, and when the number of orthodontic stages exceeds a reference number, the computing device 100 may adjust the target orthodontic movement amount of the first tooth to increase so that the first tooth is additionally corrected by the target orthodontic movement amount of the second tooth.

As another example, when the separation distance between the first individual tooth model and the second individual tooth model is less than the preset threshold value, the computing device 100 may determine the target orthodontic movement amount of the first tooth to be 0, and when the number of orthodontic stages exceeds the reference number, the computing device 100 may change the target orthodontic movement amount of the second tooth to the target orthodontic movement amount of the first tooth to cause the first tooth to be corrected as much as the second tooth is corrected.

Next, the computing device 100 may generate a plurality of unit orthodontic treatment plans corresponding to each of a plurality of stages on the basis of the target orthodontic movement amount of the first individual tooth model.

In various embodiments, when correcting the first tooth according to each of the plurality of unit orthodontic treatment plans, the computing device 100 may correct the target orthodontic movement amount of the first tooth included in each of the plurality of unit orthodontic treatment plans on the basis of a root separation distance between the first tooth and the second tooth.

More specifically, first, when correcting a crown region of the first individual tooth model according to a specific unit orthodontic treatment plan, the computing device 100 may calculate an expected orthodontic movement amount of a root region of the first individual tooth model.

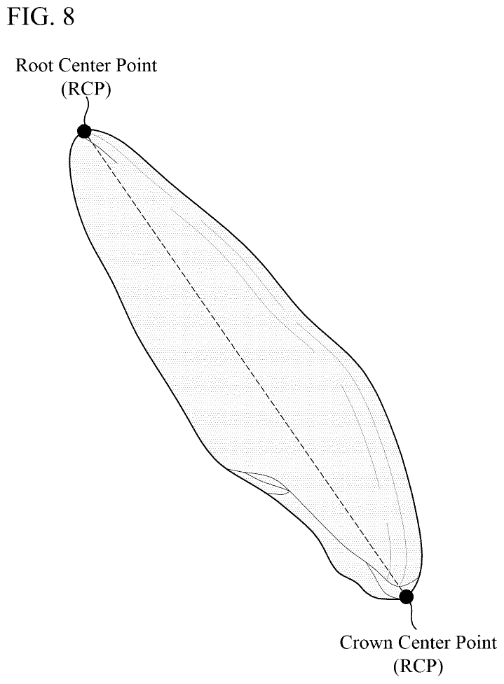

For example, as shown in FIG. 8, the computing device 100 may calculate a CCP as a feature point from the crown region of the first individual tooth model, extract a root center point (RCP) as a feature point from the root region, and set an axis in a longitudinal direction of the first individual tooth model by connecting the CCP to the RCP.

Further, the computing device 100 may calculate an expected position and expected direction for the root region of the first individual tooth model as the expected orthodontic movement amount of the root region of the first individual tooth model when the crown region of the first individual tooth model is corrected by a predetermined orthodontic movement amount using the axis set in the first individual tooth model.

Thereafter, the computing device 100 may calculate a root separation distance, which is based on the root regions of the first individual tooth model and the second individual tooth model when correcting the crown region of the first individual tooth model according to the specific unit orthodontic treatment plan, on the basis of the expected orthodontic movement amount of the root region of the first individual tooth model.

Thereafter, the computing device 100 may correct the target orthodontic movement amount of the first tooth on the basis of the root separation distance between the first individual tooth model and the second individual tooth model. For example, when the root separation distance between the first individual tooth model and the second individual tooth model is less than a threshold value, the computing device 100 may correct the target orthodontic movement amount of the first tooth so that the root separation distance between the first individual tooth model and the second individual tooth model is greater than or equal to the threshold value.

In operation S330, the computing device 100 may generate an orthodontic treatment plan using the plurality of unit orthodontic treatment plans generated in operation S320.

In various embodiments, the computing device 100 may generate an orthodontic treatment plan that allows each of the plurality of unit orthodontic treatment plans to be sequentially performed.

The orthodontic treatment plan generated as described above is as shown in FIGS. 11 to 14, and as shown in FIGS. 11 to 14, the orthodontic treatment plan allows a tooth to be corrected by a maximum orthodontic movement amount when a separation distance from an adjacent tooth is large, and allows the tooth to be corrected by an extent that the tooth is spaced apart from the adjacent tooth when the separation distance from the adjacent tooth is small, or allows the tooth to be maintained in a current position when the separation distance from the adjacent tooth is very small or when the tooth is attached to the adjacent tooth, and thus a realistically feasible orthodontic treatment plan may be generated.

The above-described method of generating an orthodontic treatment plan based on the sequential staging technology has been described with reference to the flowcharts illustrated in the drawings. For a brief description, the method of generating an orthodontic treatment plan based on the sequential staging technology has been illustrated and described as a series of blocks, but the present disclosure is not limited to the order of the blocks, and some blocks may be performed in a different order from those illustrated and performed herein or may be performed simultaneously. In addition, the method of generating an orthodontic treatment plan based on the sequential staging technology may be performed with new blocks not described in this specification and drawings added or with some blocks deleted or changed.

The above-described method may be provided as a computer program stored in a computer-readable recording medium for execution on a computer. The medium may be a computer-executable program that is permanently stored or temporarily stored for execution or download. Further, the medium may be various recording devices or storage devices in the form of a piece of hardware or a combination of pieces of hardware, and is not limited to a medium directly connected to a computer system, but may also be distributed over a network. Examples of the medium may include magnetic media such as hard disks, floppy disks, and magnetic tape, optical recording media such as compact disc read-only memories (CD-ROMs) and digital video discs (DVDs), magneto-optical media such as floptical disks, and media configured to store program instructions, including a ROM, a RAM, and a flash memory. Further, other examples of the medium may include app stores that distribute applications, sites that supply or distribute various software, and recording or storage media managed by servers or the like.

The methods, operations, or techniques of the present disclosure may be implemented with various devices. For example, these techniques may be implemented in hardware, firmware, software, or a combination thereof. It will be understood by those skilled in the art that the various illustrative logical blocks, modules, circuits, and algorithm steps described in conjunction with the present disclosure may be implemented in electronic hardware, computer software, or a combination of both. To clearly describe this interchangeability of hardware and software, various exemplary components, blocks, modules, circuits, and steps have been generally described above from their functional perspectives. Whether such functionality is implemented in hardware or software depends on the specific application and the design requirements imposed on the overall system. It should be understood by those skilled in the art that, although the described functionality may be implemented in various ways for each specific application, such implementations are not interpreted as causing a departure from the scope of the present disclosure.

In the case of implementing in hardware, processing units used to perform the techniques may be implemented within one or more ASICs, DSPs, digital signal processing devices (DSPDs), programmable logic devices (PLDs), FPGAs, processors, controllers, microcontrollers, microprocessors, electronic devices, other electronic units designed to perform the functions described herein, computers, or combinations thereof.

Therefore, the various exemplary logical blocks, modules, and circuits described in conjunction with the present disclosure may be implemented as or performed by any combination of a general-purpose processor, a DSP, an ASIC, an FPGA, other programmable logic devices, discrete gates, transistor logic, discrete hardware components, or those designed to perform the functions described herein. The general-purpose processor may be a microprocessor, but alternatively, the processor may be any conventional processor, a controller, a microcontroller, or state machine. The processor may also be implemented as a combination of computing devices, for example, a combination of a DSP and a microprocessor, a plurality of microprocessors, one or more microprocessors in conjunction with a DSP core, or any other such configuration.

In the case of implementing in firmware and/or software, the techniques may be implemented as instructions stored on computer-readable media, such as a RAM, a ROM, a non-volatile RAM (NVRAM), a programmable ROM (PROM), an EPROM, an EEPROM, a flash memory, a compact disc (CD), a magnetic or optical data storage device, or the like. The instructions may be executed by one or more processors and cause the processor(s) to perform certain aspects of the functionality described herein.

In the case of implementing in software, the techniques described above may be stored on or transmitted through a computer-readable media as one or more instructions or code. The computer-readable media includes both a computer storage medium and a communication medium, including any medium that facilitates transmission of a computer program from one place to another. The storage medium may be any available medium that can be accessed by a computer. As a non-limiting example, the computer-readable media may include a RAM, a ROM, an EEPROM, a CD-ROM or other optical disk storage, magnetic disk storage or other magnetic storage devices, or any other medium that can be used to carry or store desired program code in the form of instructions or data structures and that can be accessed by a computer. Further, any connection is appropriately referred to as the computer-readable media.

For example, when software is transmitted from a website, server, or other remote source using coaxial cable, fiber optic cable, twisted pair, digital subscriber line (DSL), or wireless technologies such as infrared, radio, and microwave, the coaxial cable, the fiber optic cable, the twisted pair, the DSL, or wireless technologies such as infrared, radio, and microwave are included within the definition of media. The disk and disc used herein include CDs, laser discs, optical discs, DVDs, floppy disks, and Blu-ray discs, wherein disks usually reproduce data magnetically, while discs reproduce data optically using lasers. The combinations of the above should also be included within the scope of the computer-readable media.

A software module may reside in a RAM, a flash memory, a ROM, an EPROM, an EEPROM, a register, a hard disk, a removable disk, a CD-ROM, or any other form of storage medium known in the art. An exemplary storage medium may be connected to a processor such that the processor may read information from a storage medium or write information to the storage medium. Alternatively, the storage medium may be integrated into the processor. The processor and the storage medium may reside within an ASIC. The ASIC may reside within a user terminal. Alternatively, the processor and the storage medium may reside as separate components within the user terminal.

Although the embodiments described above have been described as utilizing aspects of the subject matter currently disclosed in one or more standalone computer systems, the present disclosure is not limited thereto and may be implemented in conjunction with any computing environment, such as a network or distributed computing environment. Furthermore, the aspects of the subject matter in the present disclosure may be implemented in a plurality of processing chips or devices, and the storage may be similarly affected across a plurality of devices. These devices may include PCs, network servers, and portable devices.

According to various embodiments of the present disclosure, by performing accurately modeling not only on crown regions but also on root regions to generate a 3D teeth model and using the generated 3D teeth model to generate an orthodontic treatment plan, a more accurate orthodontic treatment plan can be established.

Further, in generating an orthodontic treatment plan including a plurality of orthodontic stages for the purpose of utilizing transparent orthodontic devices, by determining an amount of orthodontic movement for teeth in consideration of a positional relationship between the teeth, that is, separation distances from adjacent teeth, each tooth can be corrected in stages within an orthodontically correctable range.

Effects of the present disclosure are not limited to the above-described effects and other effects which have not been described may be clearly understood by those skilled in the art from the above descriptions.

While the present disclosure has been described with reference to some embodiments herein, it should be understood by those skilled in the art that various modifications and changes may be made without departing from the scope of the present disclosure. Further, it is intended that the modifications and changes fall within the scope of the appended claims.

1. A method of generating an orthodontic treatment plan based on a sequential staging technology, which is a method performed by a computing device, the method comprising:
generating a three-dimensional (3D) teeth model including a plurality of individual tooth models generated by individually modeling each of a plurality of teeth of a subject; and
generating an orthodontic treatment plan for performing stepwise orthodontic treatment on teeth requiring orthodontic treatment among the plurality of teeth using the generated 3D teeth model.

2. The method of claim 1, wherein the generating of the orthodontic treatment plan includes:
setting a plurality of orthodontic stages on the basis of an initial position and a target position of at least one individual tooth model, which corresponds to at least one tooth requiring orthodontic treatment, among the plurality of individual tooth models;
generating a plurality of unit orthodontic treatment plans corresponding to each of the plurality of set orthodontic stages on the basis of a positional relationship between the plurality of individual tooth models in each of the plurality of set orthodontic stages; and
generating an orthodontic treatment plan for sequentially performing each of the plurality of generated unit orthodontic treatment plans.

3. The method of claim 2, wherein the generating of the plurality of unit orthodontic treatment plans includes:
in any one of the plurality of set orthodontic stages, calculating a separation distance between the at least one individual tooth model and an adjacent individual tooth model corresponding to an adjacent tooth positioned in an orthodontic treatment direction of the at least one tooth;
determining a target orthodontic movement amount of the at least one tooth on the basis of the calculated separation distance; and
generating a unit orthodontic treatment plan corresponding to an orthodontic stage subsequent to the any one orthodontic stage according to the determined target orthodontic movement amount.

4. The method of claim 3, wherein the determining of the target orthodontic movement amount includes, when the calculated separation distance is greater than or equal to a preset reference orthodontic movement amount, determining the reference orthodontic movement amount to be the target orthodontic movement amount of the at least one tooth.

5. The method of claim 3, wherein the determining of the target orthodontic movement amount includes, when the calculated separation distance is less than a preset reference orthodontic movement amount, determining the calculated separation distance to be the target orthodontic movement amount of the at least one tooth.

6. The method of claim 3, wherein the determining of the target orthodontic movement amount includes, when the calculated separation distance is less than a preset threshold value, determining the target orthodontic movement amount of the at least one tooth to be 0.

7. The method of claim 3, wherein, in the determining of the target orthodontic movement amount, the target orthodontic movement amount of the at least one tooth is determined based on the calculated separation distance, and
the determining of the target orthodontic movement amount includes, when the number of the set orthodontic stages exceeds a reference number, correcting the determined target orthodontic movement amount of the at least one tooth according to a predetermined target orthodontic movement amount of the adjacent tooth.

8. The method of claim 3, wherein the calculated separation distance is a crown separation distance calculated based on a crown region of the at least one individual tooth model and the adjacent individual tooth model, and
the determining of the target orthodontic movement amount includes:
when orthodontic treatment is performed on the crown region of the at least one individual tooth model according to the generated unit orthodontic treatment plan, calculating an expected orthodontic movement amount of a root region of the at least one individual tooth model;
calculating a root separation distance on the basis of the root region of the at least one individual tooth model and a root region of the adjacent individual tooth model, on the basis of the calculated expected orthodontic movement amount; and
correcting the target orthodontic movement amount of the at least one tooth included in the generated unit orthodontic treatment plan on the basis of the calculated root separation distance.

9. The method of claim 8, wherein the calculating of the root separation distance includes:
setting an axis in a longitudinal direction of the at least one individual tooth model on the basis of a feature point extracted from the crown region of the at least one individual tooth model and a feature point extracted from the root region of the at least one individual tooth model; and
calculating an expected orthodontic movement amount of the root region of the at least one individual tooth model, when the crown region of the at least one individual tooth model is corrected by a predetermined orthodontic movement amount, on the basis of the set axis.

10. The method of claim 1, wherein the generating of the 3D teeth model includes:
segmenting teeth scan data into a plurality of first regions corresponding to each of the plurality of teeth;
segmenting teeth computed tomography (CT) data into a plurality of second regions corresponding to each of the plurality of teeth; and
generating a plurality of individual tooth models by registering the plurality of segmented first regions and the plurality of segmented second regions and generating a 3D teeth model by placing each of the plurality of generated individual tooth models at a position of a tooth corresponding to each of the plurality of generated individual tooth models.

11. A computing device comprising:
a processor;
a network interface;
a memory; and
a computer program that is loaded into the memory and executed by the processor,
wherein the computer program used in a method performed by the computing device includes:
an instruction for generating a three-dimensional (3D) teeth model including a plurality of individual tooth models generated by individually modeling each of a plurality of teeth of a subject; and
an instruction for generating an orthodontic treatment plan for performing stepwise orthodontic treatment on teeth requiring orthodontic treatment among the plurality of teeth using the generated 3D teeth model.

12. A non-transitory recording medium which is readable by a computing device, on which a computer program for performing a method of generating an orthodontic treatment plan based on a sequential staging technology is recorded, and which is coupled to the computing device, wherein the method includes:
generating a three-dimensional (3D) teeth model including a plurality of individual tooth models generated by individually modeling each of a plurality of teeth of a subject; and
generating an orthodontic treatment plan for performing stepwise orthodontic treatment on teeth requiring orthodontic treatment among the plurality of teeth using the generated 3D teeth model.
